(19) United States
(12) Patent Application Publication
(10) Pub. No.: US 2007/0189484 A1
(43) Pub. Date: Aug. 16, 2007

(54) System and method for enabling external service logic for calls involving number portability LRNs

(75) Inventors: Ruth Schaefer Gayde, Naperville, IL (US); Cynthia Florkey, Chicago, IL (US); John Richard Rosenberg, Elmhurst, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/342,409

(22) Filed: Jan. 30, 2006

(51) Int. Cl. H04M 3/42

(52) U.S. Cl. 379/201.01

(57) ABSTRACT

A system and method for handling a call involving Number Portability in a telecommunications network is provided. A Call Control Entity (CCE) detects a Location Routing Number (LRN) event invoking service logic on an External Network Entity (ENE), separate from the CCE, to provide enhanced service for ported calls.

### BACKGROUND OF THE INVENTION

This invention relates to a system and method for handling Number Portability Calls and more particularly to a system and method for providing enhanced services for calls involving Location Routing Numbers. While the invention is particularly directed to the art of telecommunications networks, and will be thus described with specific reference thereto, it will be appreciated that the invention may have usefulness in other fields and applications.

Number Portability enables wireless subscribers, and at least some wireline subscribers, to switch their telecommunications Service Providers without having to change their phone numbers. Switching from one Service Provider to another while maintaining the same number is also known as porting to another Service Provider (and the Service Provider's network).

In order to enable an end-user to port to another network and still receive their calls in their new network, Service Providers use Location Routing Numbers. A Location Routing Number is a 10-digit number, stored in a database, that identifies the home switch for subscriber's local telephone exchange. When a phone number is dialed, the switch receiving the dialed call performs a Number Portability Query that finds the Location Routing Number associated with the dialed number. The Location Routing Number provides the routing information for sending the call to the subscriber's home switch. Consequently, a subscriber can change Service Providers, which changes their home switch, but keep their phone number simply by having a new Location Routing Number associated with their phone number.

Today, for calls that involve Number Portability queries and Location Routing Numbers, there is no way to involve an external network entity to provide enhanced services based on the fact that this is a ported call, or a call ported to a specific LRN.

For example, a mobile user A may incur a reduced billing rate or even make calls at no charge to another mobile user B having the same Service Provider. But, if mobile user B ports to another service provider, these calls won't receive this treatment anymore since B is now with another Service Provider. It is desirable to enable the Service Provider to provide enhanced service, such as notifying the calling party A, or even the called party B, upon the occurrence events such as this.

Additionally, some service providers may designate particular LRNs to be used for particular classes of port-in subscribers. For example, some port-in users may be prepaid users, and the Service Provider may give all port-ins the same LRN. It is desirable to tailor the treatment of calls based on the particular LRN that is used to complete the call.

The present invention contemplates a new and improved that resolves the above-referenced difficulties and others.

### SUMMARY OF THE INVENTION

A system and method for handling calls involving Number Portability in a telecommunications network is provided. A Call Control Entity (CCE) detects a Location Routing Number (LRN) event in order to invoke service logic on an External Network Entity (ENE), separate from the CCE, to provide enhanced service for ported calls.

In one aspect of the invention the method includes detecting an LRN event at the CCE, invoking external logic residing in an ENE separate from the CCE for executing logic on the LRN, and initiating an Action to provide a service based on the results obtained from the ENE executing the logic.

In another aspect of the invention the system includes a CCE having means for detecting an LRN event, means for invoking external logic residing in an ENE separate from the CCE for executing logic on the LRN, and means for initiating an Action to provide a service based on the results obtained from the ENE executing the logic.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system in accordance with the invention;

FIG. 2 is a flow chart illustrating a method in accordance with the invention;

FIG. 3 is a block diagram illustrating an example of a system in accordance with the invention;

FIG. 4 is a flow chart illustrating an example of a method in accordance with the invention;

FIG. 5 is a block diagram illustrating an example of a system in accordance with the invention; and

FIG. 6 is a flow chart illustrating an example of a method in accordance with the invention.

### DETAILED DESCRIPTION OF THE PREFERRED EMBODIMENTS

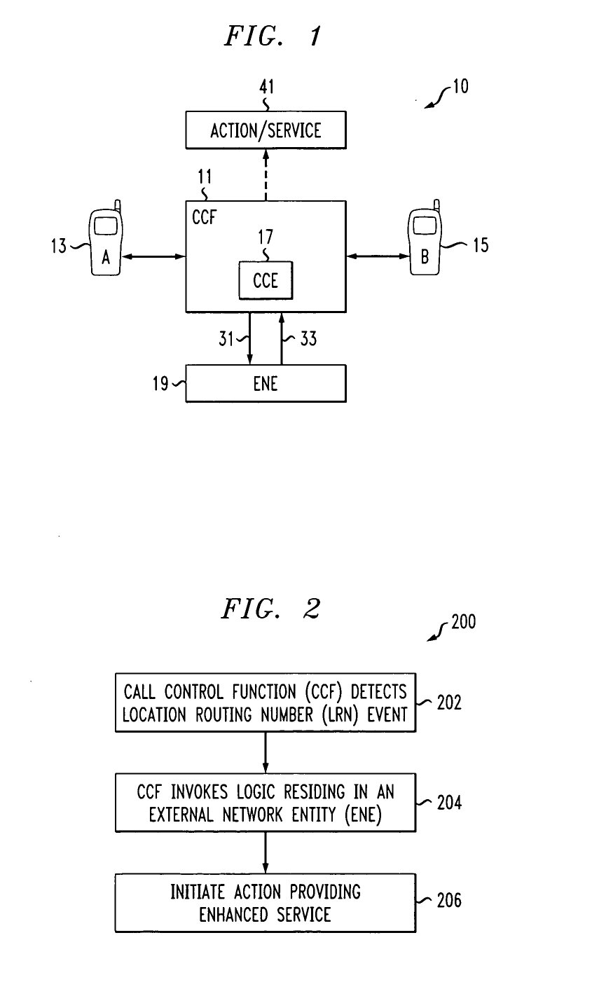

Referring now to FIGS. 1 and 2, a system 10 and method 200 are shown for providing enhanced telecommunications services for calls involving the use of Location Routing Numbers. The system 10 includes a Call Control Function (CCF) 11 for providing call control functions such as call handling, and call routing, etc. to a calling party A using a phone 13, and/or a called party B's using a phone 15. The CCF 11 can be part of a wireless telecommunications network or a wireline telecommunications network. The phones 13, 15 can be mobiles, also known as wireless terminals or cellular phones, among others, or wireline telephones, or some combination thereof. The CCF 11 includes a Call Control Entity (CCE) 17 that can be a Mobile Switching Center (MSC), and/or a switch for providing wireline switching, examples of which can include, but are not limited to a 5E switch, among others.

The method 200 includes the CCF 11 detecting a Location Routing Number (LRN) event at 202 by recognizing that an incoming or outgoing call involves the use of an LRN, typically resulting from an instance of Number Portability as described in further detail below. The CCF 11 detects the LRN event by recognizing an LRN event trigger, which can be accomplished in a variety of manners, examples of which can include but are not limited to, recognizing LRN information in the signaling for an incoming call or by recognizing LRN information in the response to a Number Portability query. The LRN event can be determined from the use of any LRN in general, or the use of a specific LRN.

Upon detection of the LRN event, the CCF 11 invokes logic residing in an External Network Entity (ENE) 19 that is separate from the CCF at step 204 to provide enhanced services, examples of which shall be described herein. The CCF 11 invokes the ENE service logic by communicating with the ENE 19 using messaging, such as by sending a query 31. Upon executing some or all of the logic, the ENE 19 provides a response to the CCF 11, shown at 33. This query response includes information for initiating one or more actions 41 at 206 to provide the enhanced services. Examples of the action taken can include, but are not limited to, playing a message to A and/or B via phones 13 and/or 15, ending the call, initiating a billing action, or other actions.

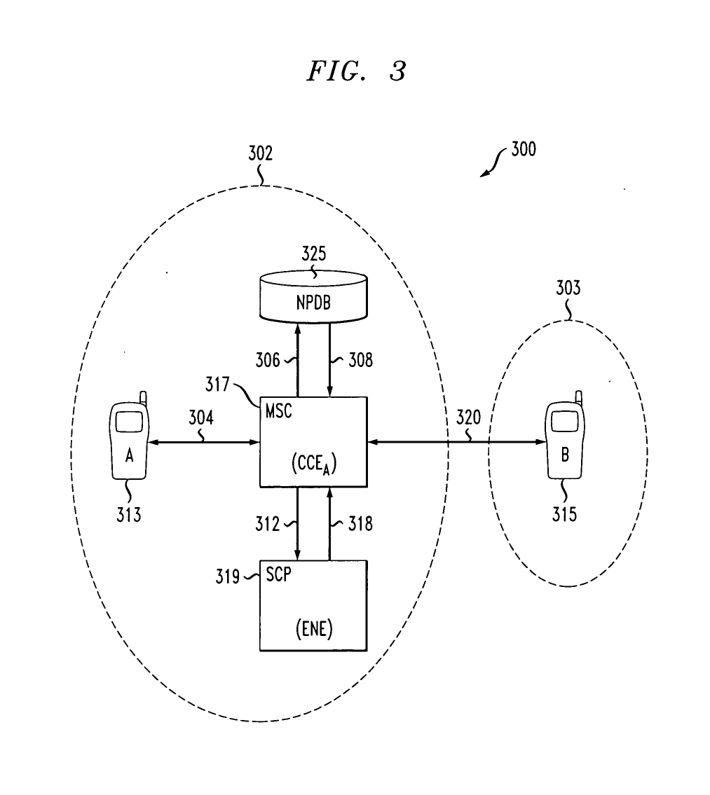

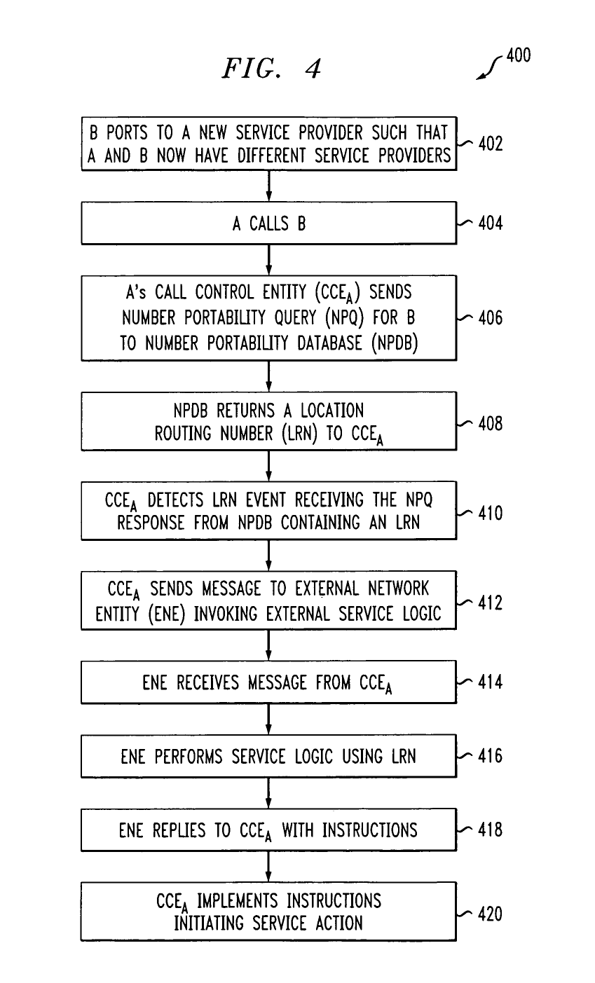

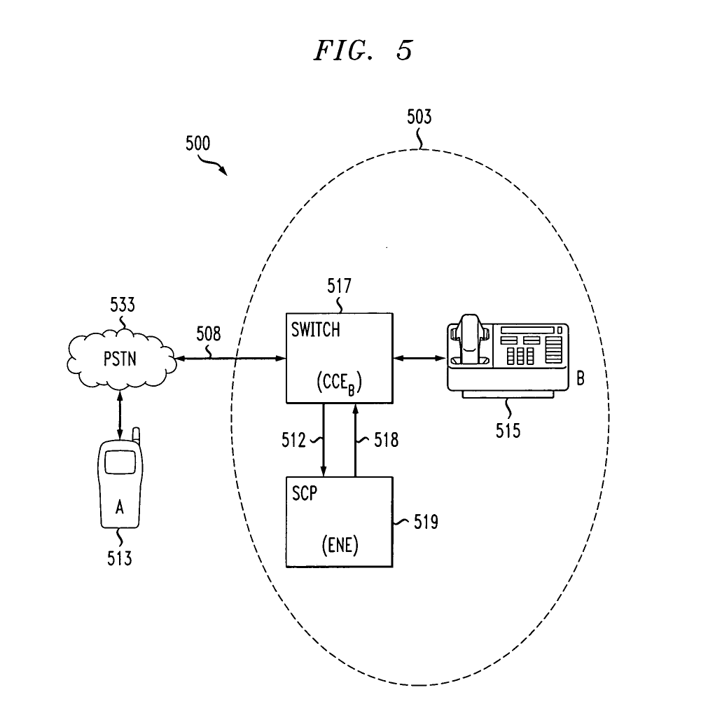

An example of the system 10 detecting the LRN event from a call origination is shown generally at 300 in FIG. 3. The method of operation of the system 300 is illustrated generally at 400 in FIG. 4. Referring to FIGS. 3 and 4, a portion of a wireless telecommunications network, shown at 302, is operated by the calling party A's Service Provider. In this example, the network is a CDMA or TDMA wireless network utilizing ANSI-41 messaging suitable for such networks, though it should be appreciated that this example is applicable to other wireless networks, such as Global System for Mobile Communications (GSM) networks or Universal Mobile Telephone System (UMTS) networks, using similar messages in Mobile Application Part (MAP) protocols, or others, suitable for such networks. Further, it should be appreciated that this call origination example is also applicable to call terminations to wireline phones in wireline networks, wherein the CCE_{A} can be a 5E switch, or other suitable CCE.

As indicated at step 402, the called party B ports from A's Service Provider's network 302 to a different telecommunications network provided by a different Service Provider as shown at 303, thereby retaining the same phone number. Using a mobile phone 313, calling party A calls called party B's mobile 315 as indicated at 404.

Calling party A's Call Control Entity (CCE_{A}), which in this example is an MSC 317, receives the call setup signal 304, such as signals sent when A dials B's Directory Number and presses the SEND button on the mobile. The MSC 317 sends a Number Portability Query (NPQ) 306 for B to a Number Portability Data Base (NPDB) 325 as part of the call origination processing at 406. The query 306 can be made using a known protocol suitable for the network 302, such as for example an ANSI-41 NPQuery Invoke message. The NPDB 325 obtains an LRN for B, since B has ported to a new service provider, and returns the LRN to the MSC 317 in a NPQ response 308 at step 408.

In this call origination example, the LRN event occurs when the MSC 317 receives the NPQ response 308 containing the LRN. The MSC 317 detects this LRN event at 410 and sends a message 312 containing the LRN to the ENE, a Service Control Point (SCP) 319 in this example, invoking external service logic on the LRN at the SCP at 412. Other examples of this messaging 312 can include, but are not limited to, Advanced Intelligent Network (AIN) messaging having a new trigger type of LRN, or an IS-771 Analyzed_Information message with trigger type=LRN, or a SIP message indicating an LRN call.

The SCP 319 receives the query message 312 from the MSC 317 at 414 and performs service logic using the LRN at 416. The SCP 319 generates a query reply 318 from the results of executing some or all of the service logic and sends it back to the querying MSC 317 at 418. The reply 318 includes one or more instructions for initiating one or more Service Actions and the MSC 317 implements them thereby initiating the Service Actions at 420. For example, the instructions can direct the MSC 317 to play an announcement to A, via A's mobile 313, indicating “Calls are no longer free because the called party B has ported”. Announcements can also be provided to the called party B's mobile 315, if so desired. Other examples can include, the query response 318 returning billing information with instructions to the MSC 317 to have it placed in the billing record, or instructions directing the MSC to tear down the call. The MSC 317 then proceeds to implement these instructions initiating these Service Actions.

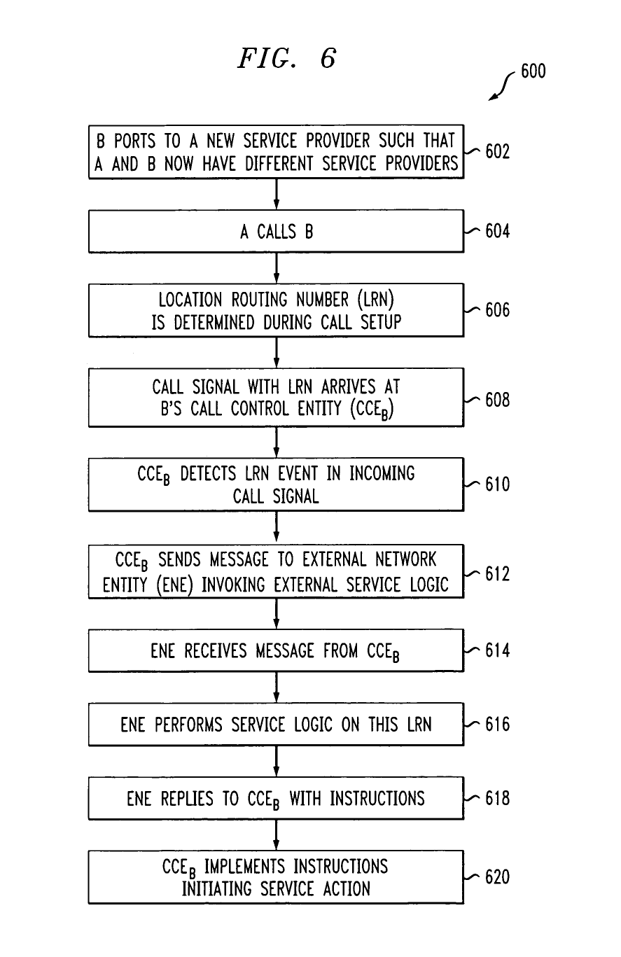

Referring now to FIGS. 5 and 6 an example of the system 10 detecting the LRN event from a call termination is shown generally at 500 and the method of operation of this system is illustrated generally at 600. The called party B has ported to the wireline telecommunications network 503 as indicated in step 602, so that calls made to B arrive at B's Call Control Entity (CCE_{B}) with B's LRN, the LRN belonging to B's Service Provider. In this example, the telecommunications network 503 is a wireline telecommunications network, and B's CCE_{B} is B's home Switch 517, such as for example a 5E switch, though it shall be referred to hereinafter as CCE_{B}. However, it should be appreciated that this call termination example is also applicable call terminations to mobiles in wireless networks, wherein the CCE_{B} can be an MSC or other suitable CCE.

The calling party A using phone 513, which can be a mobile or a wireline phone, calls the called party B's wireline phone 515 at 604. The called party B's LRN is determined at step 606, before the incoming call, shown at 508, arrives at CCE_{B} from the Public Switched Telephone Network (PSTN) 533 at step 608. The LRN can be determined, for example, in A's switch, or in a long distance network, etc. In this example, the incoming call set-up signal 508 is an ISUP Initial Address Message (IAM) including the called party number set to the LRN, the calling party number, and the Generic Address Parameter providing the actual dialed digits for B.

In this call termination example, the LRN event occurs when the CCE_{B} 517 receives the incoming call set-up signal 508 containing B's LRN. The CCE_{B} 517 detects the LRN event at 610 by recognizing the signal 508 containing the LRN as an LRN event. Upon detecting the LRN event, CCE_{B} 517 sends a message to an ENE, a Service Control Point (SCP) 519 in this example, invoking external logic at 612. Other examples of this messaging 512 can include, but are not limited to, Advanced Intelligent Network (AIN) messaging having a new trigger type of LRN, or an IS-771 Analyzed_Information message with trigger type=LRN, or a SIP message indicating an LRN call.

The SCP 519 receives the query message 512 at 614 and performs service logic using this LRN at 616. The SCP 519 generates a query reply 518 from the results of executing some or all of the service logic and sends it back to the querying CCE_{B} at 618. The reply 518 includes with one or more instructions for initiating one or more Service Actions and the CCE_{B} implements them thereby initiating the Service Actions at 620. For example, the query response 518 it can direct the CCE_{B} to play an announcement to A, via A's phone 513 saying “Your friend has ported to Acme Telecom. Why don't you too?”

Detecting the LRN event can include distinguishing particular LRNs thereby resulting in specific call treatment for calls using those one or more particular LRN. Such treatment can include the generation of LRN-specific messaging sent to particular a ENE for the execution of specific service logic and the initiation of particular Service Actions. For example, B's Service Provider can use LRNs to designate a particular group of subscribers, such as using the same LRN for designating prepaid port-in subscribers. By distinguishing these one or more particular LRNs, the ENE can direct the CCE to involve a prepaid billing platform for the group. In this manner, a simple and effective means for providing specific call treatment (services) for a group, or class, of subscribers can be provided.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of handling a call in a telecommunications network made from a calling party A using a calling party phone to a called party B using a called party phone, the method comprising:
detecting a Location Routing Number (LRN) event at a Call Control Entity (CCE);
invoking external logic residing in an External Network Entity (ENE) separate from the CCE for executing logic on the LRN; and
initiating an Action to provide a service based on the results obtained from the ENE executing the logic.

2. The method defined in claim 1 wherein the step of invoking external logic further comprises sending a query from CCE to the ENE including the LRN.

3. The method defined in claim 1 wherein the step of initiating the Action includes receiving a query response sent from the ENE at CCE including one or more instructions for initiating the Action.

4. The method defined in claim 1 wherein the step of detecting the LRN event includes distinguishing one or more particular LRNs as a group.

5. The method defined in claim 4 wherein the step of invoking the external logic includes invoking specific logic for the group.

6. The method defined in claim 4 wherein the step of initiating the Action includes providing a particular LRN-specific call treatment for the group.

7. The method defined in claim 1 wherein the CCE is the calling party's CCE (CCE_{A}) and the step of detecting the LRN event comprises the CCE_{A} receiving a Number Portability query response from a Number Portability Database containing an LRN.

8. The method defined in claim 1 wherein the CCE is the called party's CCE (CCE_{B}) and the step of detecting the LRN event comprises the CCE_{B} receiving a call setup message containing an LRN.

9. The method defined in claim 1 wherein the step of initiating an Action includes at least one of playing an announcement to a calling party and/or called party, performing a billing action, tearing down a call, and providing a specific call treatment.

10. A system for handling a call in a telecommunications network made from a calling party A using a calling party phone to a called party B using a called party phone, the system comprising:
a Call Control Entity (CCE) having means for detecting a Location Routing Number (LRN) event;
means for invoking external logic residing in an External Network Entity (ENE) separate from the CCE for executing logic on the LRN; and
means for initiating an Action to provide a service based on the results obtained from the ENE executing the logic.

11. The system defined in claim 10 wherein the means for invoking external logic further comprises sending a query from CCE to the ENE including the LRN.

12. The system defined in claim 10 wherein the means for initiating the Action includes means for receiving a query response sent from the ENE at CCE including one or more instructions for initiating the Action.

13. The system defined in claim 10 wherein the CCE includes means for distinguishing one or more particular LRNs as a group.

14. The system defined in claim 13 wherein the means for invoking the external logic includes means for invoking specific logic for the group.

15. The system defined in claim 13 wherein the means for initiating the Action includes means for providing a particular LRN-specific call treatment for the group.

16. The system defined in claim 10 wherein the CCE is the calling party's CCE (CCE_{A}) and the means for detecting the LRN event includes receiving a Number Portability query response from a Number Portability Database containing an LRN.

17. The system defined in claim 10 wherein the CCE is the called party's CCE (CCE_{B}) and the means for detecting the LRN event includes receiving a call setup message containing an LRN.

18. The system defined in claim 10 wherein the means for initiating an Action includes at least one of playing an announcement to a calling party and/or called party, performing a billing action, tearing down a call, and providing a specific call treatment.
